(19) United States
(12) Patent Application Publication
(10) Pub. No.: US 2008/0301474 A1
(43) Pub. Date: Dec. 4, 2008

(54) Performance Analysis Based System Level Power Management

(75) Inventors: Nagaraju Bussa, Hyderabad (IN); Harsh Dhand, Mohali (IN); Balakrishnan Srinivasan, Bangalore (IN)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/158,996

(22) PCT Filed: Dec. 21, 2006
(86) PCT No.: PCT/IB2006/055013

§ 371 Date: Jun. 23, 2008

Related U.S. Application Data
(60) Provisional application No. 60/753,983, filed on Dec. 23, 2005.

(51) Int. Cl. G06F 1/32

(52) U.S. Cl. 713/300

(57) ABSTRACT

A multiprocessor system-on-chip 102 with dynamic adaptive power management for execution of data-dependent applications comprises strategically placed performance counters to collect run-time performance requirements of tasks. A power manager 130 issues DVS 132, DFS 134, time-out 136, and other controls to the various system resources being monitored. As the tasks execute during run-time, the quality of the match between the task and the resource it was scheduled to is analyzed. More accurate power controls and schedules are then made available and stored in a performance requirements table. The power-management is therefore adaptive and dynamic. During a static analysis phase, applications and tasks that can be pre-characterized for their performance requirements are profiled and pre-loaded as initial starting points for correction during run-time.

This invention relates to dynamic adaptive power management in system-on-chip implementations containing either single or multiple processors, and in particular to optimizing power consumption at the system level with run-time performance counters that help in accurately judging the needs of multimedia applications that are highly data-dependant.

Power saving techniques are required because many modern devices have severe thermal and battery-power constraints. The processor clock frequency and its operating voltage largely determine its power consumption and heat generation. Microprocessors used in battery powered mobile/handheld devices are particularly sensitive to power, and therefore try to use the lowest supply voltage that can still produce the necessary performance.

Increasingly complex multi-media applications on portable platforms require ever greater computation capabilities and operating power. The special hardware circuits now used to minimize power requirements are still not enough to meet the demands. On the other hand, the optimal power levels for different SoC components cannot be predicted by simply looking into the applications, the SoC, or the scheduling and the mapping algorithms. Hence aggressive power management schemes are needed, that dynamically follow the software application's requirements and the system hardware architecture in run-time.

What makes performance estimation difficult in terms of accuracy, particularly in multimedia applications is that they are data dependent. New applications need to be power-managed as effectively as are pre-installed and pre-characterized programs. Some devices have download capability that will constantly introduce new applications. The statically defined power management generalizations cannot be applied to the new applications as they differ in the behaviour and cannot bridge all the many different mapping and scheduling implications efficiently. And in any application, the mapping and/or scheduling could be dynamic.

Prior art, state-based application-behavior prediction strategies are not very accurate. Multi-media applications performance behavior is data dependent. Path based strategies using application knobs to define the power levels are not able to follow the data dependent behavior of applications. They also do not provide a complete system view for power optimization. What is needed is run-time extraction of application performance requirements. This can be achieved by using hardware performance counters. These help gauge the exact performance and measure the real power requirements of the application.

Conventional performance monitoring uses some hardware counter or register that an executing program can tickle as it executes. The counts accumulated indicate program activity, and the counts they increase per unit time can indicate program's utilization of the hardware/resource on which it's executing. When a processor's executing rate can be varied, it is important to know if the processor is running too fast and wasting power, or if it's running too slow and being overrun.

Hardware Performance counters can monitor the utilization of system's physical components such as processors, memory, and networks. When used with application programs, performance counters can capture performance-related data about that application. The published counter information is captured and you can then compare it against acceptable performance criteria. Hardware performance counters are provided as an intrinsic part of many modern processors and cores.

For every operating voltage, static CMOS based processors have a corresponding maximum operating frequency. Lowering the frequency will proportionally reduce the power consumption. But reducing the voltage will reduce the power consumption as the square, because

$$Δ P = \frac{Δ {E}^{2}}{Z}$$

Lowering both the operating frequency and supply voltage will lead to cubic reductions in power consumption.

Dynamic frequency scaling (DFS) and dynamic voltage scaling (DVS) are conventional techniques that can be implemented with programmable clock generators and programmable, variable voltage DC/DC converters.

Many prior art commercial processors use DVS to conserve power, e.g., Transmeta Crusoe, Intel XScale, and Philips Trimedia TM3260 processors. The Philips NEXPERIA PNX1500 uses V2F dynamic power management which enables devices to conserve power by providing capability to alter frequency and core voltage. When the PNX1500 is configured with an external, programmable core voltage regulator, its software-programmable clocks enable the CPU to run at lower speeds, reducing power consumption during less cycle-consuming tasks. For example, decoding an MP3 audio stream requires less than 30 MHz of CPU cycles. Power can be conserved by adjusting the clock speed and the external voltage while the lower cycle requirement is being serviced.

The intelligence to dynamically employ DFS and DVS in devices and the technology for the system level power management is required to be developed. The ARM Intelligent Energy Manager (IEM) aims the same, but is restricted to only to the processor core. The idea is described in Flautner, et al., United States Patent Application US 2005/0097228 A1, published May 5, 2005. However their approach does not have a good starting point, because of lack of static analysis phase. Many multimedia applications have an unstable initial phase and because of this, the IEM approach will take a long time to adapt.

Monitored performance data has been used for dynamic voltage and frequency scaling controls for power management. Murthi Nanja describes “Performance monitoring based dynamic voltage and frequency scaling,” United States Patent Application US 2005/0132238 A1, published Jun. 16, 2005. The dynamic techniques used in conventional operating systems typically use interval-based schedulers to predict a future workload. Such schemes use uniform-intervals of 30-100 milliseconds to inspect the processor utilization of the previous interval. The data collected is then used to set the voltage level for the next interval. Interval-based scheduling algorithms are simple and easy to implement, but they assume the future will be a repeat of the past. So they cannot predict the future workload accurately when an application workload changes, as can be the case for data-dependent events. Interval-based schedulers make predictions which are unrelated to future workloads. There is no mechanism by which the utilization factor could be made to accurately predict future workload. Hence, Interval-based schedulers cannot scale the voltage and frequency of the processor at runtime based on actual usage patterns of the executing application.

The solutions to power management must therefore be dynamic, adaptive, and accurate. A dynamic and adaptive approach is needed for determining the optimal power requirements based on the dynamic performance requirements of multimedia applications on SoC and integrate an adaptive power manager using the dynamically predicted performance requirements.

In an example embodiment, a multiprocessor system-on-chip with dynamic adaptive power management for execution of data-dependent applications comprises strategically placed performance counters to collect actual run-time performance of tasks. A power manager employs one of DVS, DFS, time-out, and other controls to the various system resources being monitored. As the tasks execute during run-time, the quality of the match between the task and the resource it was scheduled to is analyzed. More accurate performance requirements and the corresponding power levels and there by the controls and schedules are then made available and stored in a performance requirements table. The power-management is therefore adaptive and dynamic. During a static analysis phase, applications and tasks that can be pre-characterized for their performance requirements are profiled and pre-loaded as initial starting points for correction during run-time.

An advantage of the present invention is that a method is provided that is generic enough to capture the system level performance requirements for practically any SoC platform for executing data-dependent applications and optimally manage the power consumption for the system-level.

The above summary of the present invention is not intended to represent each disclosed embodiment, or every aspect, of the present invention. Other aspects and example embodiments are provided in the figures and the detailed description that follows.

The invention may be more completely understood in consideration of the following detailed description of various embodiments of the invention in connection with the accompanying drawings, in which:

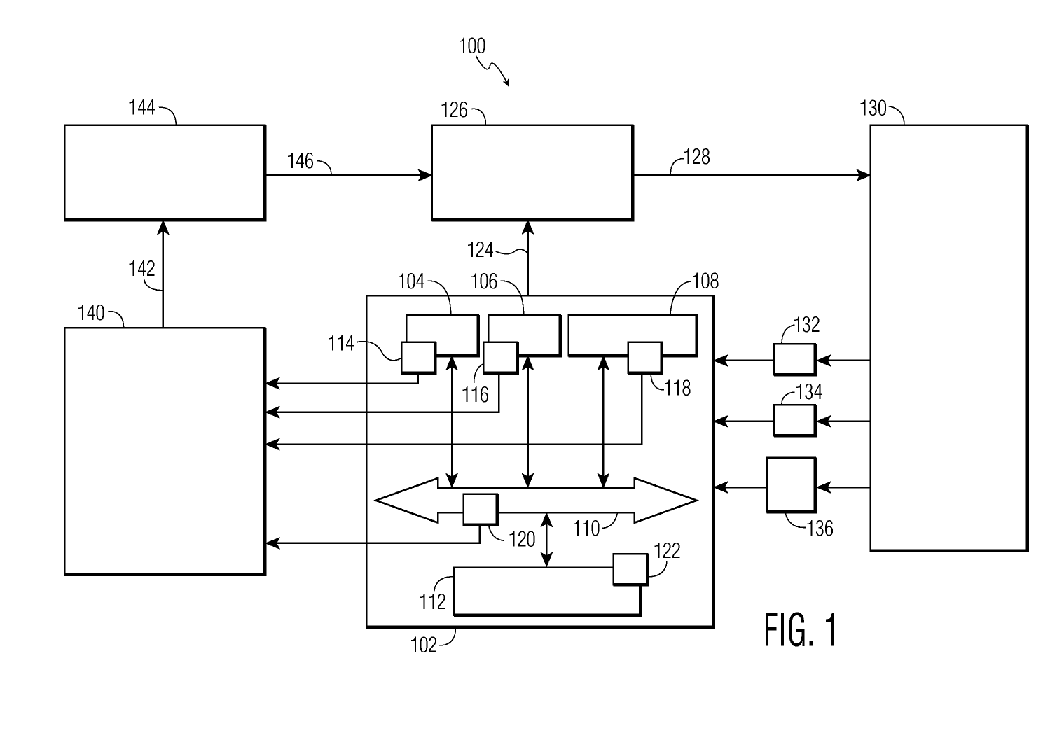

FIG. 1 is a functional block diagram of adaptive dynamic power management embodiment of the present invention that uses performance counters distributed throughout a system-on-chip implementation of a multiprocessor system; and

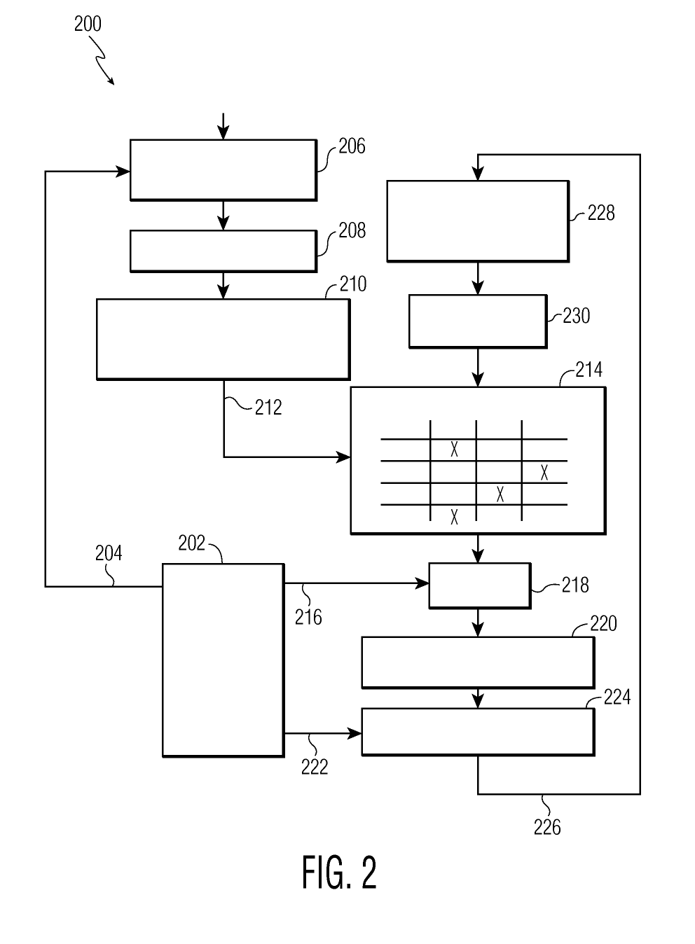

FIG. 2 is a flowchart diagram of a method embodiment of the present invention that uses performance counters to provide adaptive dynamic power management in a system-on-chip implementation of a multiprocessor system.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

FIG. 1 adaptive dynamic power management system embodiment of the present invention, and is referred to herein by the general reference numeral 100. The system 100 comprises a system-on-chip (SoC) 102 with a multiprocessor system implemented with a first processor core (CPU 1) 104, a second processor core (CPU2) 106, a peripheral core 108, an internal system bus 110, and a memory 112. The run-time performance of the SoC 102 at system-level is gauged by collecting statistics from strategically placed performance counters 114, 116, 118, and 120. Such performance counters can be implemented to generate interrupts after a preloaded number has been decremented to zero. Each decrement is controlled by the executing task, and how quickly the task can decrement the count to interrupt is a measure of the performance on the real hardware during run-time.

The details of implementing performance counters can be found in several publications. So such construction details need not be included here. Gilberto Contreras, et al., describe “Power Prediction for Intel XScale Processors Using Performance Monitoring Unit Events,” in a paper presented at ISLPED '05, Aug. 8-10, 2005, San Diego, Calif. The use of performance counters and various commercial processors on the market including them are described by Flautner, et al., United States Patent Application US 2005/0097228 A1, published May 5, 2005; Murthi Nanja, in United States Patent Application US 2005/0132238 A1, published Jun. 16, 2005; by Morrie Altmejd, et al., in U.S. Pat. No. 6,895,520 B1, issued May 17, 2005; and, by David Albonesi, in U.S. Pat. No. 6,205,537 B1, issued Mar. 20, 2001. Such materials are incorporated herein by reference. A unique aspect of embodiments of the present invention is that several performance counters strategically placed in a multiprocessor system are used during run-time to adaptively and dynamically manage the power at the system-level. The publications cited here are merely describe constituent parts used in the unique combination described herein.

Referring again to FIG. 1, an operating system (OS) 122 executes from memory 112 and can host an application software comprising a series of tasks each with their own performance requirements. Such requirements can be highly data-dependent, as in streaming multimedia applications.

Some applications and their tasks will have already been profiled and a priori data about their performance requirements 124 can be communicated to a resource mapping table 126. Here, individual task performance requirements are tabulated according to which power levels and processor cores 104 and 106 can accommodate them. Such schedules 128 are forwarded to a power manager 130 in real time for run-time dynamic adaptation of power controls DVS 132, DFS 134, time-out 136, etc. These power controls can individually and independently affect CPU1 104, CPU2 106, peripheral 108, and bus 110, in a combined way that maximizes overall system-level power efficiency. Such may not necessarily be the most efficient for any one power-controllable section of the multiprocessor system, but it will be for the entire SoC 102.

During run-time execution of the application and its tasks, the performance counters 114, 116, 118, and 120 provide information about the execution statistics of the various tasks via a run-time profiler 140. A performance prediction model 144 identifies the execution phases and calculates the slack-time measurements 142 in order to update the performance levels required in the resource mapping table 126. This process produces a list of new performance requirements 146. These are used to populate table 126 and are matched with the voltage-frequency levels available.

The whole of what is illustrated in FIG. 1 is preferably fully disposed within SoC 102. FIG. 1 has exploded out some of the embedded parts in order to describe them better herein FIG. 2 represents a power-management method embodiment of the present invention that uses performance counters to provide adaptive dynamic power management in a system-on-chip implementation of a multiprocessor system. Such method is referred to herein by the general reference numeral 200. The method 200 operates with a software application 202 that can be a streaming multimedia application comprising tasks with varying performance requirements. It is the nature of the software application 202 that these tasks can be previously unknown and uncharacterized, and their exact performance requirements may only be manifested when they are actually being executed by an assigned processor core where they were scheduled. Sometimes the performance requirements will depend largely on the data being processed, and so prediction is difficult.

A list of the tasks 204 is sent to a process 206 with pre-loads for several program counters (PC) where the applications and/or use cases are already known. This begins a static analysis phase. A process 208 computes the slack-times for each of the tasks. Such slack-times indicate how much a processor core can be slowed down with DVS, DFS controls to save power and still get the job done. A process 210 maps the application/task requirements to the available processor cores at selectable optimum power levels. Initial table values 212 are preloaded into a resource requirement table 214, which also has the details of the various voltage levels at which each of the core can run and also the current running voltage levels of the various cores

Such resource requirement table 214 maps the requirements of the tasks in the application list to the optimal power levels that can be achieved by the multiprocessor system processor core. A static analysis phase initializes the table 214. A scheduler will decide exactly to which processor core to send the particular task. The resource requirement table 214 will be dynamically updated with more accurate task performance requirements during run-time. A list of tasks 216 is sent to a scheduler 218 in the sequence that the software application 202 requires them to be executed by any of the processor core resources. Such scheduler 218 consults resource requirement table 214 to see what power level is appropriate for the task. The scheduler can either schedule a processor core already operating at the proper power level, or it can call a process 220 to issue adaptive power manager controls dynamically to the scheduled processor core to change the voltage/frequency levels. A next task 222 is loaded and a process 224 executes the scheduled task on the selected processor core.

During execution, a process 228 collects statistics from performance counters strategically placed at several points in the SoC. Such performance counters can be preloaded with count-down values that will generate an interrupt at zero count. Such event can be compared to system time to gauge the on-going performance of the task and if the scheduler 218 had made an accurate power-management assignment. A process 230 extracts the dynamic performance actually occurring in run-time, and a data update 232 is loaded into the table 214. Processes 218 and 220 can correct the power manager controls if necessary this time, or for the next time the task executes.

A performance counter provides a single metric about some performance aspect of the system or application. E.g., the number of active threads in a process or the percentage of elapsed time used by threads of a process in executing instructions or the number of context switches of a task, or the number of task activations, etc. Performance counters can be organized and grouped into performance counter categories. For example, a processor category includes all counters related to the operation of a processor such as processor time, idle time, interrupt time, etc. The Windows OS provides many predefined performance counters that can be retrieved programmatically or displayed using a Performance Monitor. These counters are used to monitor the usage of operating system resources. Conventional implementations typically equip only a part of the system, e.g., the processor. Here, system-level power-management is based on performance requirements of applications, for optimizing the overall power consumption at the system level.

Performance analysis and dynamic power management are combined herein to obtain an efficient power management scheme. The performance counters deal with workload dependent applications, and help adapt to any new applications run on the SoC. After an initial training of an optimal power policy model, power measurements are gathered for the whole system, and the information is fed back into a power policy model. Such use of hardware performance counters leads to more accurate prediction, compared to the OS obtained historical view of execution as exemplified by the ARM IEM. The present invention methodology is generic enough to capture system-level performance requirements for any platform.

Experiments for characterizing streaming applications verified that it is possible to identify the execution phases of multimedia applications on multiprocessor platforms with varying workloads and that use dynamic scheduling. Performance numbers for the execution times, the activation times, and the number of context switches, were collected during initialization, stable, and finalization phases during the execution of an application on the system. Once the three phases were characterized, the power management techniques were used efficiently to minimize the system level power consumption.

The present power optimization method includes both static and dynamic analysis parts. Dynamic voltage scaling for power optimization requires knowledge of the slack time, i.e., the difference between the current execution time of the task and the corresponding task deadline. The task deadline can be determined during static analysis. The current execution time cannot be predicted with accuracy. So here it is based on a dynamic prediction model which gathers data from the hardware performance counters. Such determines the actual tasks execution phases of the application.

The static analysis uses a high-level analytical model with parameters for the real-time requirements, e.g., in terms of task deadlines. The behavior of the system and the performance parameters that can be analyzed before run-time are done at design time.

During run-time, the execution cycles, context switch changes, activation times are monitored with the several performance counters. An execution cycles count measures the application's execution requirements. An activation times and context switch data performance count quantifies the overhead associated with those activities. If a task makes too many context switches in a short time, it may not be advantageous to try using voltage scaling because the switch itself idles the processor a small amount of time. Changing the supply voltage typically needs 100-200 milliseconds for things to settle afterwards.

The prediction model 144 estimates the dynamic performance of application tasks using the performance counters, and assigns the appropriate power requirements to them. The power manager 130 uses this information dynamically for run-time power management. The power management freely adapts to different input data and new applications, while meeting the performance requirements.

The static analysis collects the performance counters for known applications and use cases. An off-line analysis of these numbers is used to find the slack-times, i.e., the time differences between an application's performance requirements and the actual computation time of the application on the processor. The resource requirement and voltage level mapping table maps the application requirements to optimum power levels. The power manager uses this table to dynamically apply the appropriate power policy like DVS, DFS, time out, etc. at various phases of the application for optimal system level power consumption. The static analysis is a starting point for power management, as it profiles the benchmark applications for known data sets.

New use cases, and even whole new applications, are managed for power by embedding dynamic analysis into the SoC 102. During the dynamic analysis phase, the dynamic behavior extracted from the execution phases or performance requirements of the applications is captured with a statistical performance prediction model. Dynamic prediction requires the run-time profiling capability to gather the numbers from the hardware performance counters and do the analysis. The output of the prediction model is used to update the table, which maps the requirements versus optimal power levels at run-time. The power manager uses this table to effectively apply the power management policy on the fly.

Power management can be integrated at various points in a system. It can be incorporated at the hardware level, firmware level, user level, or the application level. Power management at the hardware level cannot see or use the application's dynamic behavior requirements. The global state of the system is not known at the hardware level. The user doesn't know component characteristics, and can't make the frequent decisions needed for accurate power management. Using application level controls for power management must be done without knowing the dynamic behavior of the application. Such controls must be inserted at compile time, or design time. At run time, when it's too late for application controls, the application's behavior will be data dependent. For multiple applications running on the same platform, individual power controls in each application cannot optimize at the system level. Only the control flow of each constituent application can be power optimized.

Significant opportunities in power management lie with application-specific performance requirements. Hence there is a need for capturing of application behavior and prediction of performance. The present invention addresses the problem of capturing the performance requirements and predicting the performance of applications for optimizing the system level power. Dynamic adaptive power management of the system considers both the hardware and the application with the help of the OS.

While the present invention has been described with reference to several particular example embodiments, those skilled in the art will recognize that many changes may be made thereto without departing from the spirit and scope of the present invention, which is set forth in the following claims.

1. A method of dynamic adaptive power management in multiprocessor system-on-chip comprising: building a resource requirements table that tabulates tasks in an application program according to their performance requirements and resource power levels available in a multiprocessor system with power management controls, also the various operating voltages of the different cores and also the current running voltage level of the cores; during a static phase, uploading resource requirements to said table; during a dynamic phase, collecting information from a plurality of strategically placed performance counters, extracting dynamic performance requirements, and updating corresponding entries in said table; consulting said table and using a power manager to set corresponding power levels to system resources scheduled for respective tasks.

2. The method of claim 1, wherein: the consulting said table and using a power manager comprises selecting one of the cores operating at required power level or using at least one of DVS, DFS, and time-out, separately applied independently to one of said systems resources.

3. The method of claim 1, wherein: the collecting information from a plurality of strategically placed performance counters is such that a performance counter is associated with each processor core, each peripheral, and an internal system bus to provide performance data.

4. The method of claim 1, wherein: the uploading resource requirements to said table is such that said performance counters issue interrupts and are preloaded for known applications and uses, and the slack-times of each are computed to pre-estimate resource requirements.

5. A multiprocessor system-on-chip (SoC) with dynamic adaptive power management for execution of data-dependent applications, characterized by: a plurality of performance counters with individual ones disposed in each processor each periphera, and an interconnecting internal system bus of a multiprocessor system implemented in a system-on-chip; a resource requirements table that maps the performance levels required for a scheduled resource by a task in an application; power manager for controlling at least one of DVS, DFS, and timeout to respective system resources associated with each of the performance counters, and that during run-time consults the resource requirements table for appropriate power management settings; a static process for pre-loading the resource requirements table with performance requirements for a list of known applications and uses; and a dynamic process for updating entries in the resource requirements table with performance requirements that have been extracted during run-time from data collected from the plurality performance c wherein, the power manager issues such controls as are necessary to optimize power at the system-level and such controls are dynamic and adaptive to changing conditions in the application that cannot be predicted before run-time.

6. The SoC of claim 5, further comprising: a run-time profiler it for capturing the performance data from the performance counters and gives it to the performance prediction model, during run-time.

7. The SoC of claim 6, further comprising: a performance requirements prediction model uses the data from the run-time profiler and predicts the performance requirements of the tasks.

8. The SoC of claim 5, further comprising: a power manager for employing one of DVS, DFS, and time-out controls to individual system resources.

9. A prediction model for predicting the dynamic performance of application tasks that uses performance c and tabulates appropriate power requirements, and a power manager for dynamically using such tabulated information for on-line power management done at run-time, and such that the power management adapts to different input data and new applications while meeting each task's performance requirements.
